(19) United States
(12) Patent Application Publication
(10) Pub. No.: US 2006/0216577 A1
(43) Pub. Date: Sep. 28, 2006

(54) Apparatus and method for reposing and reviving a chemical battery

(76) Inventor: Tsan-Hsiung Cheng, Tampa, FL (US)

Correspondence Address: BIRCH STEWART KOLASCH & BIRCH, PO BOX 747, FALLS CHURCH, VA, 22040-0747, US

(21) Appl. No.: 11/090,194

(22) Filed: Mar. 28, 2005

(51) Int. Cl. H01M 10/42; H01M 2/10

(52) U.S. Cl. 429/49; 429/99; 429/100

(57) ABSTRACT

An apparatus and method for reposing and reviving a chemical battery include a single battery unit or a plurality of battery units clustered together. The output voltage of each battery unit is coupled in series or parallel to generate a greater voltage or current output. Every two battery units are isolated by an insulation plastic sheet. All battery units are connected through a serial and a parallel conductive wires to increase current or voltage. Final positive and negative outputs are delivered through a positive output terminal and a negative output terminal. All compound agent materials, the battery insulation film, and the central power collection plate are placed sequentially in a layer manner in a metal case which has an upper side covered by a seal plug.

### FIELD OF THE INVENTION

The present invention relates to an apparatus and method for reposing and reviving a chemical battery to make the chemical battery enter a temporary dormant condition due to lack of water or to be revitalized after injecting water to start chemical reactions thereby to increase the life span of the chemical battery.

### BACKGROUND OF THE INVENTION

The conventional chemical battery, either the primary battery or the secondary battery, adopts a mechanism to transform chemical energy to DC power. The generally called dry battery or wet battery now on the market actually uses “water” as the basic substance of electrolyte. The electrolyte bridges a positive active substance and a negative active substance to perform electrolyzing, namely to activate a reducing reaction to generate positive ions and negative ions to produce the conduction in a constant direction so that electric current flowing through the positive electrode and the negative electrode forms a potential difference to generate an electron flow, or current to do work, i.e. the commonly called “the work by electrical force”. Since the water (H2O) molecule that consists of two hydrogen atoms and one oxygen atom is the basic element required in the electrochemical reaction of the battery, as long as water has been injected into the chemical reaction trough of the battery, either the primary battery or secondary battery, as most of batteries now on the market do, the chemical reaction in the battery proceeds continuously. Namely, the chemical electrolysis, a reducing reaction between the positive active substance and the negative active substance is proceeding constantly. Only the speed of electrochemical reaction differs due to the difference of use conditions. Hence the electrochemical reaction in the battery is proceeding continuously whether it is used or not, namely a natural discharging effect always exists. The general battery on the market aims to instantly generate electric current to be used after shipment. Therefore the blended compound agent filled in the battery has included water in the basic electrolyte. This is why a brand new battery on the market contains a substantial portion of water-like electrolyte when dismantled. The electrolyte is formed by blending water and strong acid or strong alkali in advance. Hydration heat is generated during the blending process. Thus, the electrolyte is moisturized and corrosive. This is why the general battery on the market has a limited shelf life.

### SUMMARY OF THE INVENTION

In view of the aforesaid problems occurred to the conventional batteries that contain a substantial portion of water-like electrolyte formed by blending water with strong acid or strong alkali in advance, and generate hydration heat during the blending process and result in moisturizing and become corrosive that impairs the shelf life, therefore the invention aims to adopt a design for the chemical battery that contains no water to enter a dormant condition temporarily, and is injected with water when in use so that it is revitalized to start chemical reactions, thereby to increase the life span of the battery.

The object of the invention is to temporarily remove water from the electrolyte in the battery or to add no water during production of the battery so that the battery enters a dormant condition to lengthen the life span of the battery when not in use, and to inject water when in use to revitalize the battery so that the total life span of the battery increases.

The chemical battery according to the invention has a greater contact area in a unit area and unit weight after adjustment. The electrolyte does not contain water during the production process. Solid electrolyte materials and other compounds are mixed in a dry condition. While a small amount of moisture in the air is blended during mixing due to relative humidity of the air, the moisture can aid evenly mixing of the materials and compounds to facilitate forming and packing. All compound agent materials, a battery insulation film and a power collection plate are placed sequentially in a layer fashion in a metal case which is covered by a seal plug on an upper side.

The foregoing, as well as additional objects, features, and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a schematic view of the invention showing a single battery and a water pouch to be assembled.

FIG. 3 is a plane view of the invention showing a plurality of batteries coupled in series.

FIG. 4A is a front view of a seal plug of a single battery of the invention.

FIG. 4B is a top view of the seal plug according to FIG. 4A.

FIG. 4C is a schematic enlarged view of the seal plug according to FIG. 4A.

FIG. 4D is a schematic view of the seal plug having a ball wedged therein according to FIG. 4C.

FIG. 4E is a top view of the seal plug according to FIG. 4D.

FIG. 5A is a front view of the invention.

FIG. 5B is a top view of a water pouch according to FIG. 5A.

FIGS. 5C and 5D are schematic views of a water injection duct of a water pouch to pierce a water inlet shown in FIG. 5A.

FIG. 6A is a schematic view of another embodiment of the water pouch of the invention.

FIG. 6B is an enlarged schematic view of a water injection duct of a water pouch to pierce a water inlet shown in FIG. 6A.

FIG. 7A is a schematic view of another embodiment of the seal plug of a single battery of the invention (not air discharged by vacuuming yet).

FIG. 7B is a front view of the seal plug according to FIG. 7A (having air discharged by vacuuming).

FIG. 8 is an exploded view of another embodiment of the invention.

FIG. 9A is a schematic view according to FIG. 8.

FIG. 9B is a schematic view according to FIG. 9A before water injection from the water pouches.

FIG. 9C is a schematic view according to FIG. 9A after water injection from the water pouches to the battery body.

### DETAILED DESCRIPTION OF THE PREFERRED EMBODIMENTS

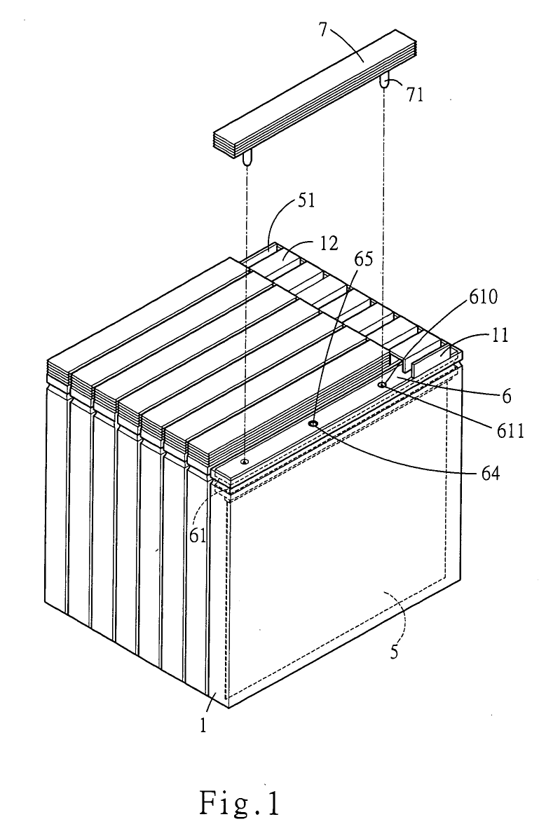

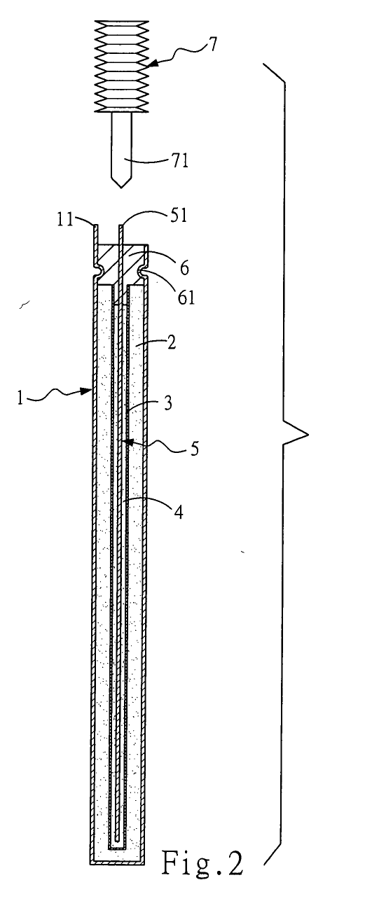

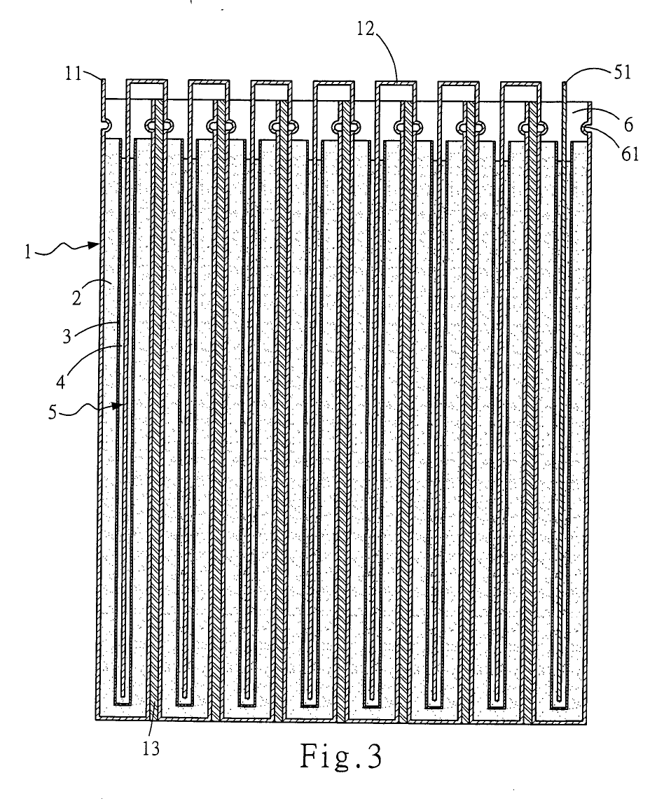

Please refer to FIG. 1. The present invention aims to provide an apparatus for reposing and reviving a chemical battery. The apparatus includes a single battery unit or a cluster consisting of a plurality of battery units that has the output voltage of each battery unit coupled in series or parallel (also referring to FIGS. 2 and 3) to form a higher voltage or a higher current output. Every two battery units are isolated by an insulation plastic sheet 13. The batteries of the entire cluster are coupled by conductive wires 12 in series and parallel fashion to increase the current or voltage. A positive output terminal 11 and a negative output terminal 51 are provided to deliver the final positive and negative output. All the compound materials, a battery isolation film 3, and a central power collection plate 5 are placed sequentially in a layer fashion in a metal case 1 which is covered by a seal plug 6 on an upper side.

The single battery unit (referring to FIG. 2) mainly includes the metal case 1 which holds a positive compound agent 2. The positive compound agent is formed by heating and compression through a mold in a selected thickness and viscosity to be bonded closely to an inner wall of the metal case 1 to become a hollow positive compound agent layer. The hollow portion of the positive compound agent layer holds a polymer film, namely the battery insulation film 3, which allows ions to pass through to generate conduction. The battery insulation film 3 has the insulation property but also allows electrochemical ions to pass through. The battery insulation film 3 has an interior space to hold a negative compound agent 4 and the central power collection plate 5. The central power collection plate 5 has a longer length and is extended above the metal case 1 to form a negative electrode for connection and conduction.

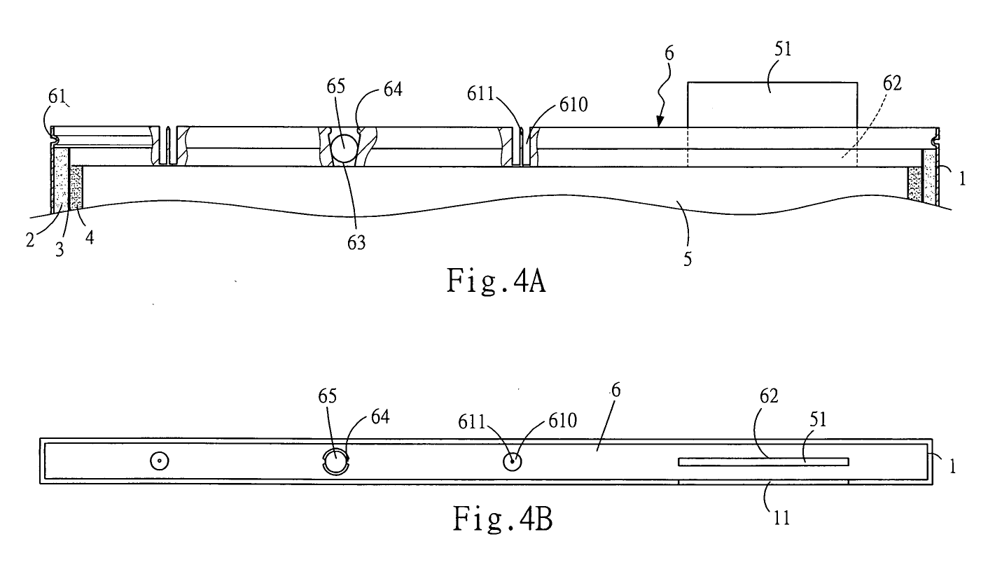

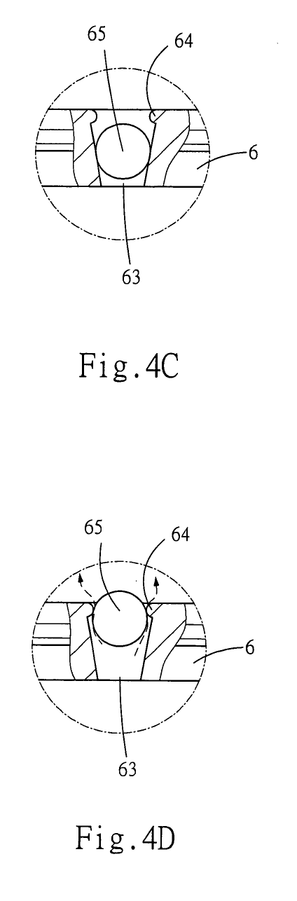

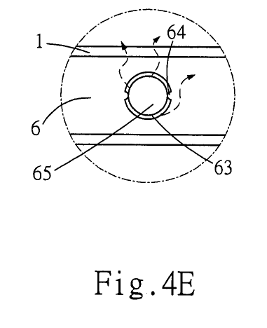

Referring to FIGS. 4A and 4B, the seal plug 6 is made of an insulation material and formed by injection molding. It has an upper layer and a lower layer. The upper layer has a larger cross section with a diameter same as the inner peripheral rim of the metal case 1 and has a groove 61 on the periphery to be wedged in the metal case 1 by a mechanical method and sealed by shellac or asphalt. The lower layer has a smaller cross section with a diameter same as the inner peripheral rim of the battery insulation film 3 and is formed in a conical manner to be wedged in the battery insulation film 3 when the seal plug 6 is inserted in the metal case 1. The seal plug 6 is coated in advance with a pliable glue to separate the positive compound agent 2 and the negative compound agent 4. The seal plug 6 has an elongated crevice 62 on one side running through the upper side and lower side thereof to enable the central power collection plate 5 to pass through to become a negative output terminal 51. The negative output terminal 51 can output electricity or be connected with another battery unit to form a series or parallel coupling (also referring to FIG. 3). The seal plug 6 has an air outlet 63 on another side that is formed in a conical fashion with a larger upper side and a smaller lower side (referring to FIGS. 4C, 4D and 4E). The larger side of the air outlet 63 has a plurality of small bulged humps 64 on the periphery formed during the plastic injection molding process. The air outlet 63 further holds a round ball 65 which is wedged therein without escaping to form a movable space on an upper side and a lower side. The seal plug 6 has a water inlet 610 which is tubular and has an inner diameter larger than or equal to the outer diameter of an injection duct 71 located on a lower side of a water pouch 7 (referring to FIG. 2). The water inlet 610 has a hard needle 611 in the center at a length slightly greater than the depth of the injection duct 71. Hence the bottom of the injection duct 71 is pierced through by the needle 611 first, and the top side of the injection duct 71 is formed in an acute angle to pierce through the bottom of the water inlet 610 to allow water contained in the water pouch 7 to be squeezed and injected into the battery.

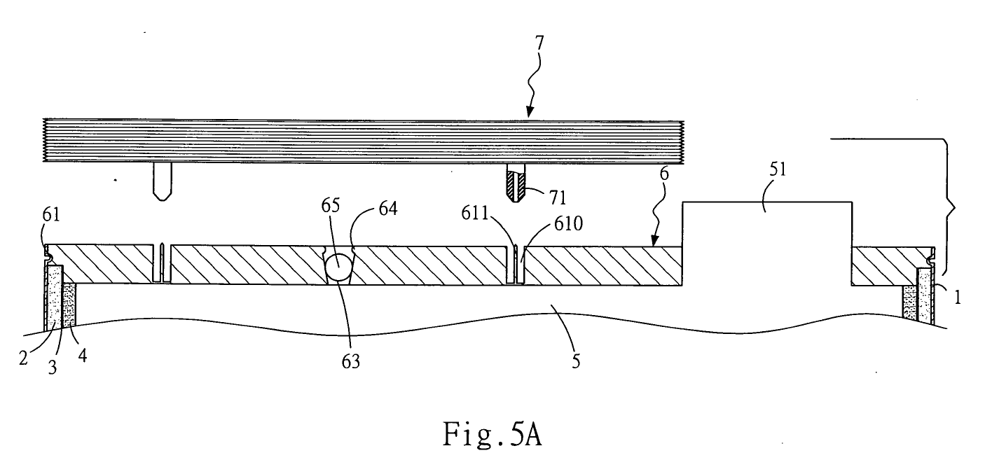

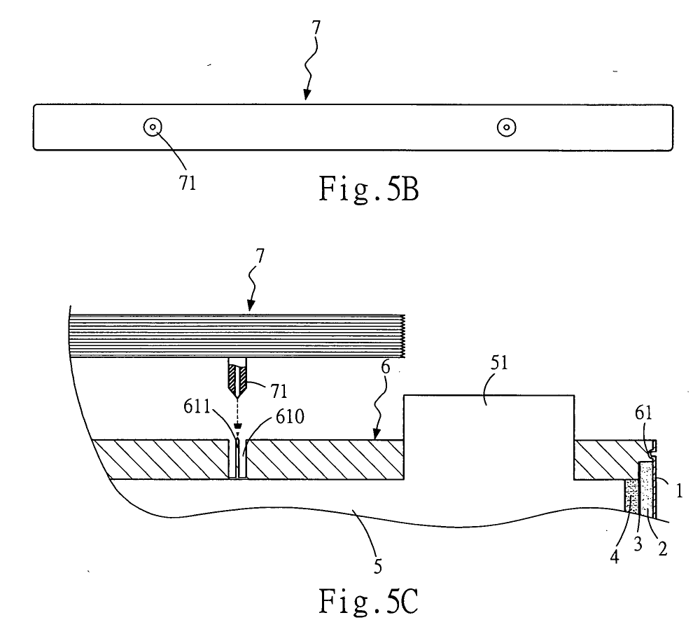

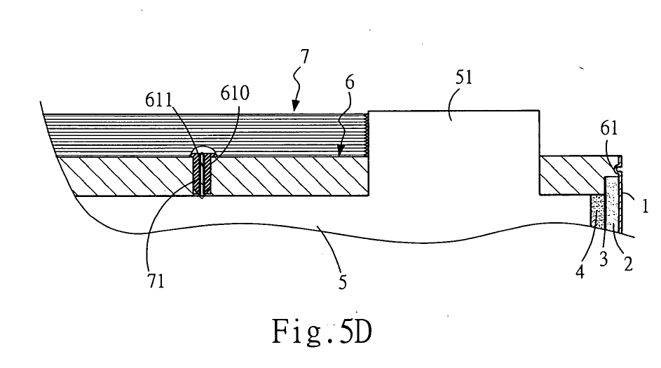

Refer to FIG. 5A for the method according to the invention:

First, produce the electrolyte without water. Mix solid electrolytic raw materials and other compounds in a dry condition. During the mixing process, a small amount of moisture in the air due to relative humidity is blended to aid the mixing evenly; then compress the materials into a selected form. The formed compound agent, the battery isolation film 3, and central power collection plate 5 are placed sequentially in a layer manner in the metal case 1. Then the metal case 1 is covered by the seal plug 6 on the upper side.

During placing all of the materials in each battery unit, a vacuuming process is needed to extract air to isolate the moisture in the air. During the vacuuming process, the round ball 65 in the conical air outlet 63 is pushed upwards by airflow resulting from vacuum suction so that the inside contained air and the remained moisture in the air are extracted and dispelled. The vacuum pump is shut down after a desired vacuum is reached. When the airflow stops, the round ball 65 drops to seal the smaller opening below to form a sealed condition and reach a first stage vacuum condition. After all manufacturing processes are finished, the battery unit is covered by a plastic bag and the inside air is extracted to form a second stage vacuum condition and a sealed packaging. Hence, influence caused by changes of the temperature and humidity in the ambience is fully isolated and the battery is temporarily maintained in a dormant condition without water, and the life span of the battery may increase.

When the battery is in use, first remove the protective plastic bag; pierce water inlet 610 of the seal plug 6 through the injection duct 71 located on the lower side of the water pouch 7 which contains a desired amount of de-ionized or distilled water (referring to FIGS. 5B, 5C and 5D). The injection duct 71 is tubular and has a bottom sealed by the water pouch body, thus the de-ionized or distilled water contained in the water pouch does not vaporize or lose. The water pouch 7 is formed with pliable folding creases on the periphery and is extensible. The water inlet 610 is also tubular and has an inner diameter greater than or equal to the outer diameter of the injection duct 71. When the injection duct 71 pierces through the water inlet 610, the hard needle 611 in the center of the water inlet 610 pierces through the bottom of the injection duct 71 first because of its longer length, and the acute angle of the top end of the injection duct 71 also pierces through the bottom of the water inlet 610, so that the water in the water pouch 7 may be squeezed to flow into the battery. The solid and granule chemical materials in the battery unit form a vacuum space to receive the pouring water evenly and smoothly. With the water injected in the chemical battery, the battery is revitalized to start chemical reactions. The electrochemical reaction generates gases which are discharged through the conical air outlet 63 and two injection ducts 71 of the water pouch 7 (referring to FIG. 5A). Thus a complete electrochemical reaction is generated.

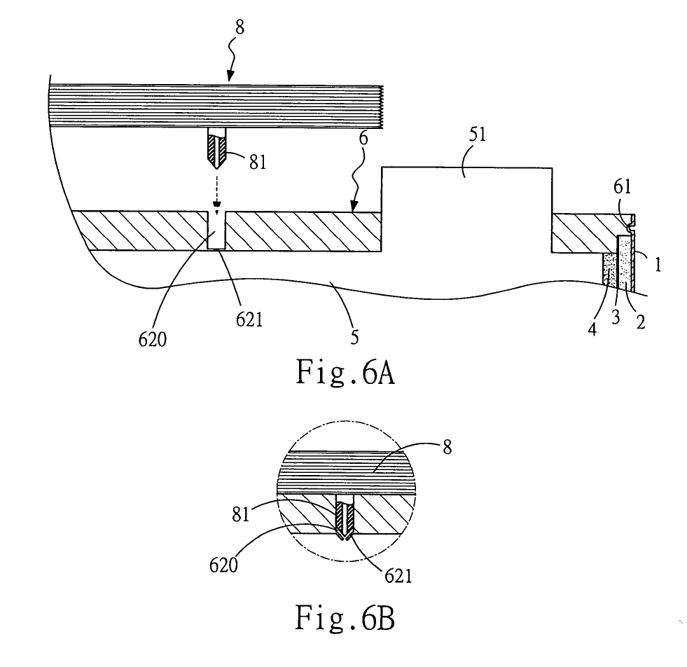

Refer to FIGS. 6A and 6B for another embodiment of the water pouch 8 of the invention. It is largely constructed like the embodiment as shown in FIG. 5A. The difference is that the water pouch 8 has an injection duct 81 which is lengthy and has a sharp and sealed bottom. When the battery is in use, first, remove the protective plastic cover. Turn the water pouch 8 to let the injection duct 81 on the upper side. Cut off the sealed portion of the injection duct 81 and pierce the injection duct 81 into the water inlet 620 of the seal plug 6 to run through the thin membrane at the bottom 621 of the water inlet 620. After that, turn the water pouch 8 and battery to let the water pouch 8 on the top of the battery. Then the de-ionized or distilled water contained in the water pouch 8 may be injected into the battery.

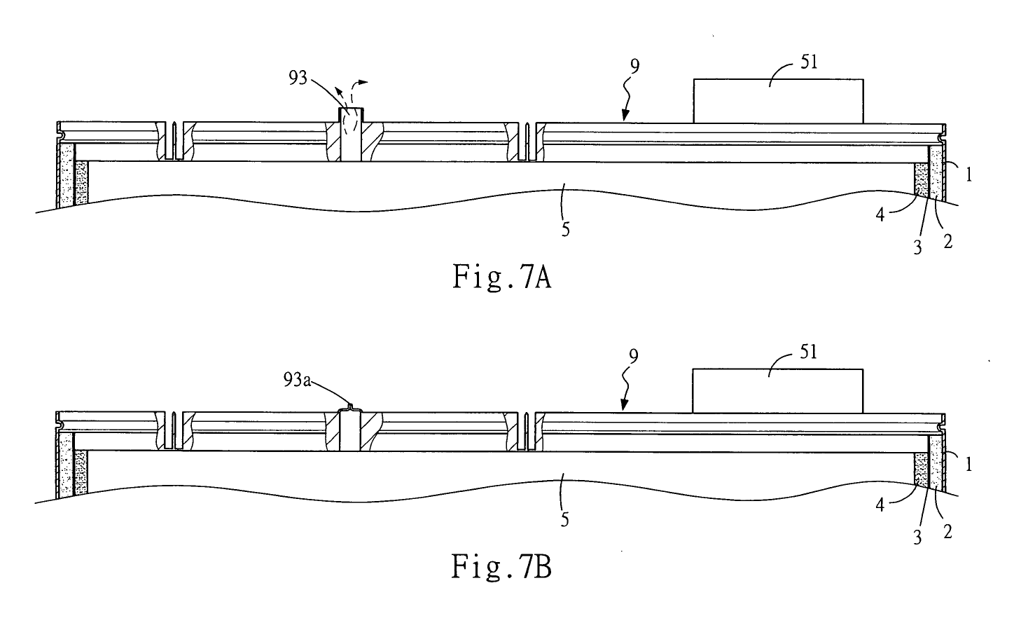

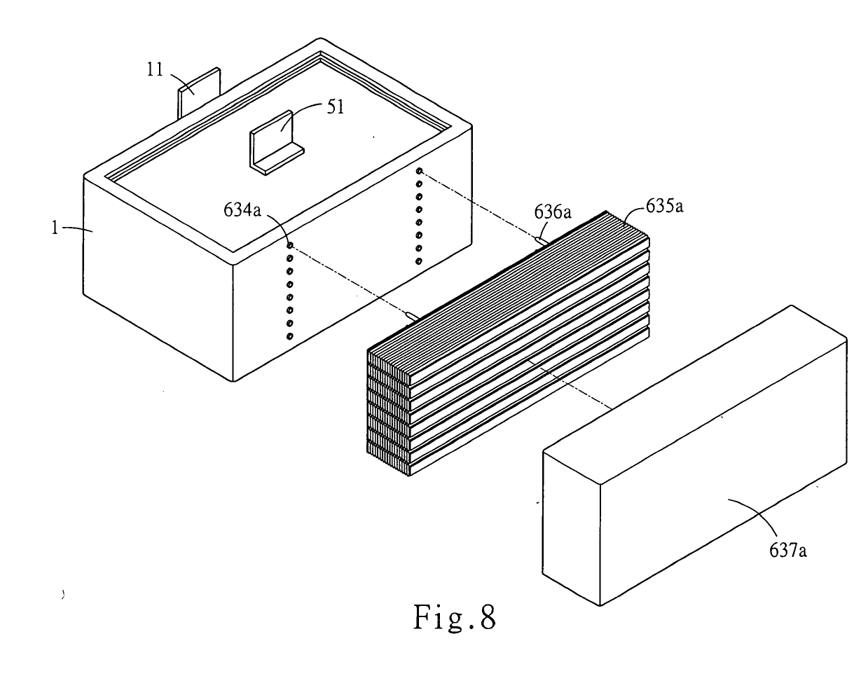

Refer to FIG. 7A for another embodiment of the seal plug 9. The seal plug 9 has an air outlet 93 on one side which is tubular and slightly extended outside the upper side of the seal plug 9. After the battery unit is vacuumed, the extended portion of the tubular air outlet 93 is heated and sealed by a heating pliers to become airtight (referring to FIG. 7B).

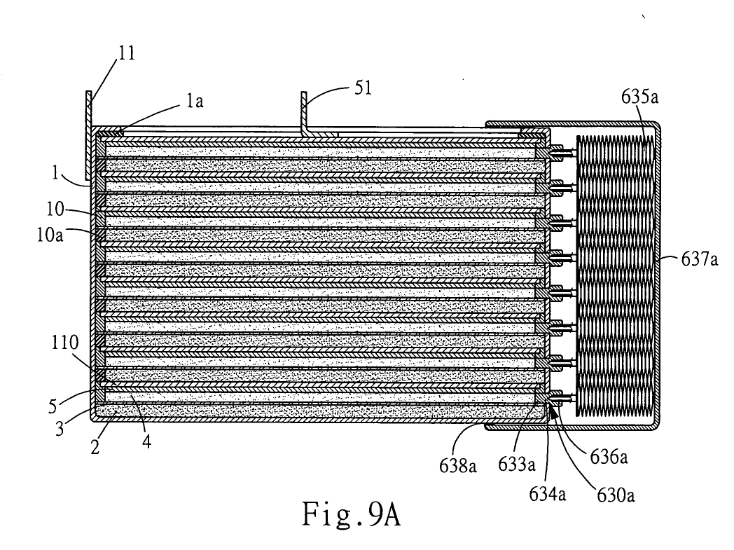

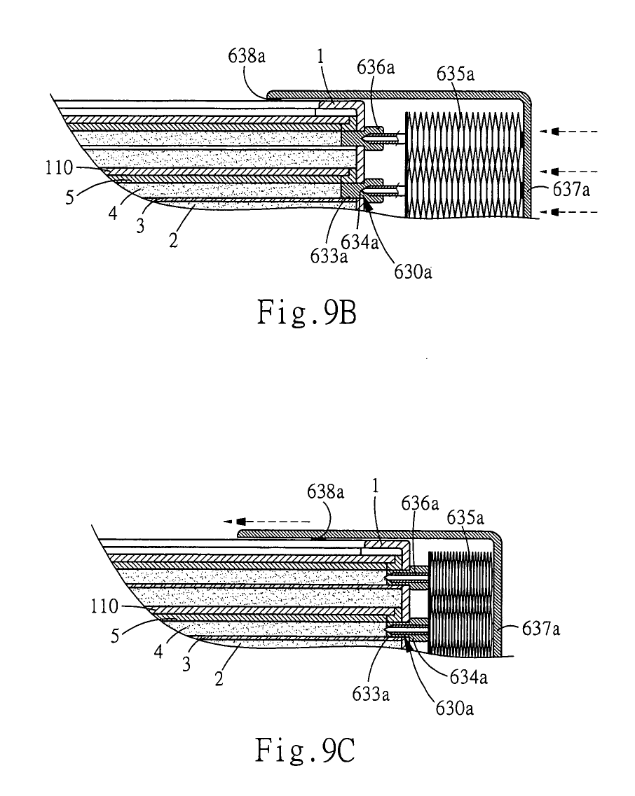

Refer to FIG. 8 for an exploded view of another embodiment of the invention. The metal case 1 is a hollow container formed by mold stamping in a round shape, rectangular shape or the like. The positive compound agent 2 is located on the bottom inside the metal case 1 and compressed to form a solid layer of a selected thickness bonding to the bottom inner wall of the metal case 1 to make the metal case 1 to become a positive electrode. Next, load a polymer film which can allow electrochemical ions to pass through, namely the battery insulation film 3; next, load a first insulation frame 10 on the battery insulation film 3 (referring to FIG. 9A); then load the negative compound agent 4 and the central power collection plate 5. The central power collection plate 5 collects negative electricity generated by electrochemical reaction of the negative compound agent 4 to become a completed battery unit. The central collection plate 5 can gather the negative electricity and transfer to a positive electrode plate 110 of another battery unit on the upper side. Then, like the process previously discussed, load a second insulation frame 10a, another positive compound agent 2, another battery isolation film 3, another first insulation frame 10, another negative compound agent 4, and another central power collection plate 5 in this order. Or a plurality of battery units may be coupled in series according to output voltage requirement.

Refer to FIG. 9B for the configuration of another embodiment of the invention. It is largely constructed like the embodiments shown in FIG. 4A which has water inlets 610 or FIG. 6A which has water inlets 620. The difference is that there is a round air outlet 633a above each water inlet 630a corresponding to each battery unit. The air outlet 633a is formed at the same time with the metal case 1 during mold stamping. After the whole battery set has been assembled, it is vacuumed to discharge the moisture inside. Then the air outlet 633a is sealed by a plug 634a made from pliable rubber to maintain a vacuum and dry condition in the interior. A water pouch 635a is located on a position corresponding to the plug 634a. The number of the water pouch 635a corresponds to the number of battery units. Each water pouch 635a has a hard needle 636a on one side that pierces in advance into the plug 634a at a depth of one half of the thickness thereof. The needle is glued to prevent water leakage from the water pouch 635a. Then the water pouch 635a is encased by a plastic shell 637a made by injection molding so that it is protected from being compressed and resulting in water leakage. The plastic shell 637a has an interior dimension slightly larger than the exterior dimension of the metal case 1, and has one half sealed the outer side of the metal case 1 and fastened temporarily by adhesives 638a on a number of spots. Then the whole product is vacuumed to become a finished product. When the battery of the invention is in use (referring to FIGS. 9B and 9C), first, remove the exterior vacuum package; push the plastic shell 637a towards the battery body to tear off the adhesives 638a, and pierce the needle 636a through the pliable rubber plug 634a so that distilled water or de-ionized water contained in the water pouch 635a can be injected into the vacuum and dry interior of the battery body to revive and start electrochemical reactions and generate a potential difference between the electrodes to output electric power.

What is claimed is:

1. An apparatus for reposing and reviving a chemical battery comprising a plurality of battery units which are clustered, each of the battery units having an output voltage which is coupled in series to generate a higher output voltage or a higher output current, every two neighboring battery units being isolated by an insulation plastic sheet, the clustered battery units being connected through a serial conductive wire to increase the current or the voltage, final positive and negative outputs being drawn from a positive output terminal and a negative output terminal, all compound agent materials and a battery insulation film, and a central power collection plate being housed sequentially in a layer fashion in a metal case which has an upper side covered by a seal plug.

2. The apparatus for reposing and reviving a chemical battery of claim 1, wherein the output voltage of each battery unit in the cluster is coupled in a parallel manner.

3. The apparatus for reposing and reviving a chemical battery of claim 1, wherein the battery is a single unit.

4. The apparatus for reposing and reviving a chemical battery of claim 1, wherein the seal plug has an upper layer and a lower layer, the upper layer having a larger cross section and a diameter same as an inner peripheral rim of the metal case, and a groove formed on the periphery to be wedged in an upper side of the metal case by a mechanical method and sealed by shellac or asphalt; the lower layer having a smaller cross section and a diameter same as an inner peripheral rim of the battery insulation film and being formed in a conical fashion to be wedged in the battery insulation film when the seal plug is inserted in the metal case.

5. The apparatus for reposing and reviving a chemical battery of claim 4, wherein the seal plug is made from an insulation material and formed by plastic injection molding, and has an elongated crevice on one side running through an upper side and a lower side thereof to allow the central power collection plate to pass through to become the negative output terminal.

6. The apparatus for reposing and reviving a chemical battery of claim 4, wherein the seal plug has an air outlet on one side that is tubular extended from an upper side of the seal plug.

7. The apparatus for reposing and reviving a chemical battery of claim 6, wherein the extended upper side of the air outlet is sealed by heating and compressing to become airtight.

8. The apparatus for reposing and reviving a chemical battery of claim 4, wherein the seal plug has an air outlet on another side formed in a conical fashion with a larger upper side and a smaller lower side.

9. The apparatus for reposing and reviving a chemical battery of claim 8, wherein the larger side of the conical air outlet has a plurality of bulged humps formed on the periphery edge, the conical air outlet holding a round ball which is confined by the bulged humps without escaping to form a movable space on an upper side and a lower side thereof.

10. The apparatus for reposing and reviving a chemical battery of claim 4, wherein the seal plug has a water inlet which is tubular and has a hard needle in the center.

11. The apparatus for reposing and reviving a chemical battery of claim 10 further having a water pouch located above the water inlet of the seal plug.

12. The apparatus for reposing and reviving a chemical battery of claim 11, wherein the water pouch has an injection duct on a lower side that is tubular and forms an acute angle on the top side.

13. The apparatus for reposing and reviving a chemical battery of claim 12, wherein the injection duct is elongated and has a sharp and sealed bottom.

14. The apparatus for reposing and reviving a chemical battery of claim 10, wherein the water inlet of the seal plug has an inner diameter greater than the outer diameter of an injection duct located on a lower side of the water pouch.

15. The apparatus for reposing and reviving a chemical battery of claim 14, wherein the water inlet of the seal plug has an inner diameter same as the outer diameter of the injection duct of the water pouch.

16. The apparatus for reposing and reviving a chemical battery of claim 10, wherein the needle has a length longer than the depth of an injection duct located on a lower side of the water pouch.

17. The apparatus for reposing and reviving a chemical battery of claim 1, wherein the metal case is formed by mold stamping which holds a positive compound agent on the bottom that is compressed to a selected thickness to be bonded to an inner wall of the metal case bottom to make the metal case to become a positive electrode, the interior of the metal case further housing the battery insulation film, a first insulation frame, a negative compound agent and the central power collection plate in this order, the central power collection plate gathering negative electricity generated by electrochemical reactions of the negative compound agent to become one battery unit, the central power collection plate gathering the negative electricity and transferring to the positive electrode plate on another battery unit on an upper layer, then loading a second insulation frame, a second positive compound agent, a second battery isolation film, another insulation frame, a second negative compound agent and a second central power collection plate in this order thereby to couple a plurality of battery units in series according to output voltage requirement.

18. The apparatus for reposing and reviving a chemical battery of claim 17, wherein each battery unit has a corresponding water inlet which is sealed by a pliable rubber plug after air discharge has been finished in the battery unit, the water inlet being corresponded to a water pouch which has a hard needle on one side and is encased by a plastic shell, the plastic shell being coupled on an outer side of the metal case and temporarily anchored by adhesives on selected locations, the battery unit being vacuumed and packaged to become a finished product.

19. A method for reposing and reviving a chemical battery for the apparatus of claim 1, comprising the steps of:
placing sequentially all materials in battery units;
removing moisture in the air in the battery units by vacuuming, and pushing a round ball upwards in a conical air outlet by airflow resulting from vacuum suction;
stopping vacuuming after a desired vacuum condition being reached to stop the airflow and drop the round ball to seal a smaller opening on a lower side to form a first stage vacuum condition;
covering the battery units by a plastic bag and vacuuming the plastic bag to form a second stage vacuum condition to isolate influences caused by changes of temperature and humidity of the ambience so that the battery is in a dormant condition due to lack of water; and
injecting water from a water pouch through a water inlet located in a seal plug on an upper side of a metal case into the chemical battery to revitalize the chemical battery and start chemical reactions.
